(19) United States
(12) Patent Application Publication
(10) Pub. No.: US 2026/0267780 A1
(43) Pub. Date: Sep. 10, 2026

(54) TESTING MODIFICATIONS TO A CODEBASE USING NEURAL NETWORKS

(71) Applicant: NVIDIA Corporation, Santa Clara, CA (US)

(72) Inventors: Vishesh Gupta, Pune (IN); Mansata Kamal, Pune (IN); Rahul Rane, Pune (IN); Vikas Bijalwan, Pune (IN); Rohit Singh, Pune (IN); Abhishek Anurag, Pune (IN); Hiren Namera, Pune (IN)

(21) Appl. No.: 19/072,267

(22) Filed: Mar. 6, 2025

(51) Int. Cl. G06F 11/3668

(52) U.S. Cl. CPC G06F 11/3688

(57) ABSTRACT

Apparatuses, systems, and methods for automated test generation using one or more neural networks. In at least one embodiment, neural network(s) are used to identify one or more effects to be produced by one or more code modifications to one or more codebases based, at least in part, on at least one change list identifying the code modification(s). Information (e.g., test cases and/or test code) is identified, which may be used to test whether the codebase(s) produce the effect(s).

### BACKGROUND

Test generation is used to create test cases that are used to evaluate performance and/or functionality of a codebase. For example, test generation may help ensure that neural networks that perform natural language processing (NLP) are able to understand, interpret, and/or generate human language effectively. When a codebase is changed, test cases may be generated to help ensure that the changes produce desired effects. A test case includes information, such as a set of conditions, a set of variable values, a set of inputs, an ordered set of test steps, test code, test script(s), and/or a set of expected results, that may be used to test whether code is working correctly and producing desired effects (e.g., a set of expected results). Traditional test generation methods involve a manual process in which test engineers analyze code changes identified in change lists (CLs), search for existing relevant test cases, and create new ones if necessary, often leading to duplication and inefficiencies. This approach often relies on comprehensive documentation of the code to be tested and the database of existing test cases, which makes it challenging for engineers to efficiently locate relevant test cases, if they exist in the database. For at least these reasons, the process of generating tests can be improved.

### SUMMARY

Embodiments of the present disclosure relate to testing modifications to a codebase using neural networks. Systems and methods are disclosed to automate the generation of test cases by using neural networks to extract semantic and functional insights from change lists. Such systems and methods may improve efficiency and accuracy in software testing.

In contrast to conventional systems, the systems and methods disclosed perform automated test generation using one or more neural networks, such as one or more language models (LM(s)), one or more large language models (LLM(s)), one or more small language models (SLM(s)), one or more vision language models (VLM(s)), one or more multi-modal language model (MMLM(s)), one or more multi-modal large language model (MLLM(s)), etc. The systems and methods may use the neural network(s) to analyze one or more CLs and/or generate test cases. The systems and methods disclosed may refine test cases by learning from previous iterations, which may improve accuracy and/or coverage over time. Additionally, the systems and methods disclosed may use an Abstract Syntax Tree (AST) to represent at least a portion of a codebase, allowing the neural network(s) to generate test cases without accessing the actual computer code. The AST may represent only a portion of the codebase being modified by changes described in the CL(s).

### BRIEF DESCRIPTION OF THE DRAWINGS

The present systems and methods for testing modifications to a codebase using neural networks are described in detail below with reference to the attached drawing figures, wherein:

FIG. 1 illustrates a block diagram illustrating an example system, in accordance with at least one embodiment;

FIG. 2 illustrates a block diagram illustrating an automated test generation process using neural networks, in accordance with at least one embodiment;

FIG. 3 illustrates a block diagram of a system for generating a condensed abstract syntax tree (AST) from a change list (CL) and codebase, in accordance with at least one embodiment;

FIG. 4 illustrates a block diagram of a system to perform a test case generation and verification process, in accordance with at least one embodiment;

FIG. 5 illustrates a graph depicting the process of automated test generation and validation using one or more neural networks, in accordance with at least one embodiment;

FIG. 6 is a flow diagram illustrating a method for automated test generation, in accordance with at least one embodiment, according to at least one embodiment;

FIG. 7 illustrates an example including a processor and modules, in accordance with at least one embodiment, according to at least one embodiment;

FIG. 8 is a block diagram illustrating a driver and/or runtime including one or more libraries to provide one or more application programming interfaces (APIs), according to at least one embodiment;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Systems and methods are disclosed related to testing modifications to a codebase using neural networks. Such systems and methods may be used to implement an automated test generation system that uses change lists (CLs) directly as sources of information. The automated test generation system analyzes code changes identified in CLs using one or more neural network(s) to extract semantic and/or functional insights, such as a type of change, impact on one or more APIs, performance implications, and/or others. The semantic and/or functional insights indicate one or more effects to be produced by the code changes. Using these extracted insights, new code features to be tested are determined, and a database of existing test cases is searched for any relevant existing test cases. The automated test generation system allows for real-time adaptation of existing test cases based on code modifications identified using CLs without the need for extensive code documentation. Furthermore, the automated test generation system can analyze multiple CLs simultaneously. The test cases may be used to test whether code changes (e.g., a new feature) produces the effect(s) indicated by the semantic and/or functional insights.

The automated test generation system may implement an iterative process that identifies existing test cases in the database that may be used to validate the code changes (e.g., a new feature). If the identified test cases are insufficient or non-existent, the automated test generation system generates new test cases using one or more neural networks. The neural network(s) may be integrated into an iterative loop that allows the neural network(s) to learn from test cases generated by previous iterations, refining the new test cases until they adequately test the new feature. The automated test generation system may generate natural language test cases and convert them into executable test code. This conversion may be facilitated or performed by one or more LM(s), such as one or more LLM(s), one or more SLM(s), one or more VLM(s), one or more MMLM(s), one or more MLLM(s), etc., fine-tuned for one or more specific projects, utilizing embeddings from documentation and/or application programming interface (API) guides.

Instead of using the code to be tested itself, the automated test generation system may use a representation of the code, such as a condensed form of an AST representing the code, which eliminates the need to expose the code itself to the neural network(s). In at least one embodiment, the automated test generation system generates an AST, for example, based, at least in part, on a sub-portion of the code, and identifies the sub-portion based, at least in part, on one or more CLs. The AST may provide information, such as function definitions, arguments, and return types, to the automated test generation system allowing the neural network(s) to generate relevant test cases without accessing the entire codebase.

In at least one embodiment, the automated test generation system uses graphs in which each node in the graphs represents a distinct processing step, such as summarizing the CLs, handling the AST, verifying code, finding test cases, generating pipelines, and/or others. This modular approach allows for human-in-the-loop (HIL) testing, where human intervention can be introduced at various stages to ensure accuracy and reliability.

In some examples, the machine learning model(s) (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for further increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

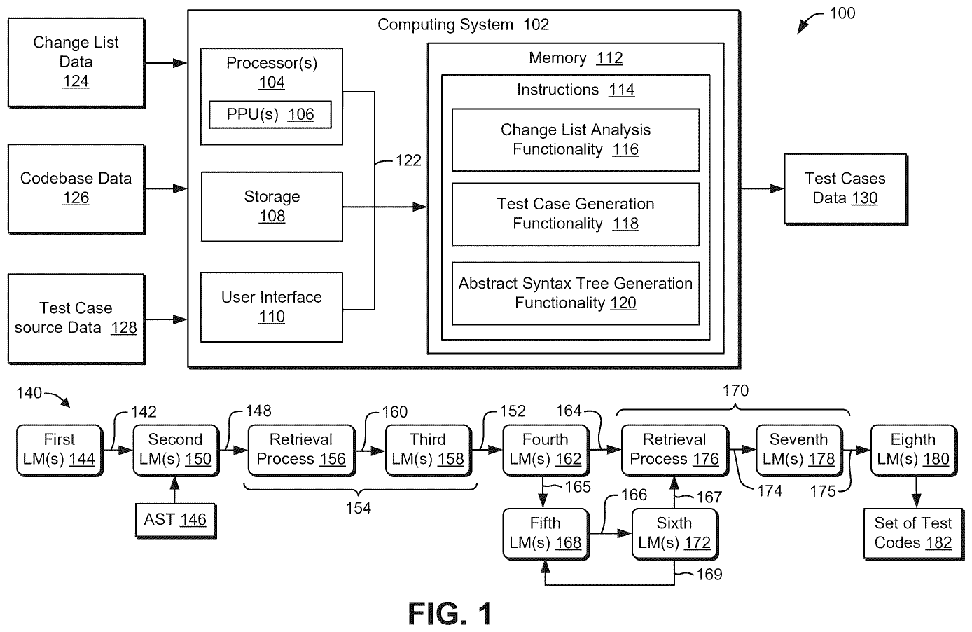

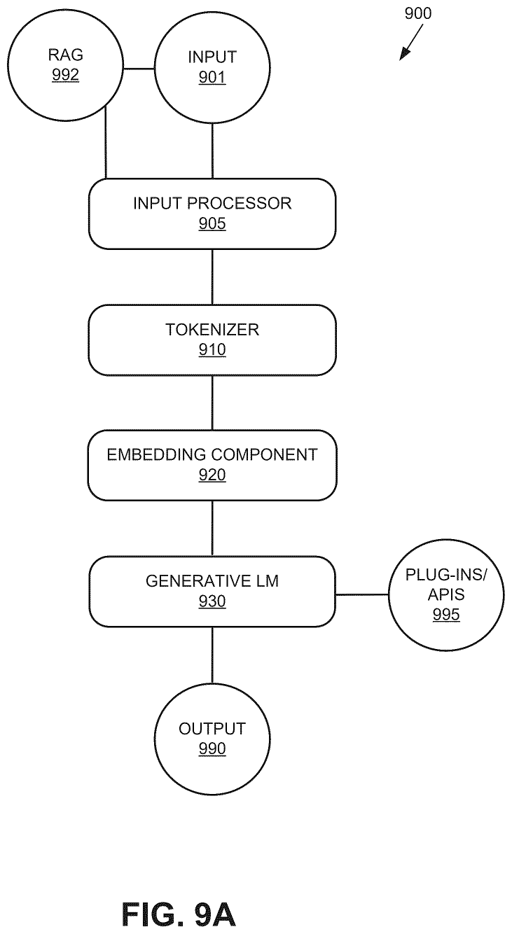

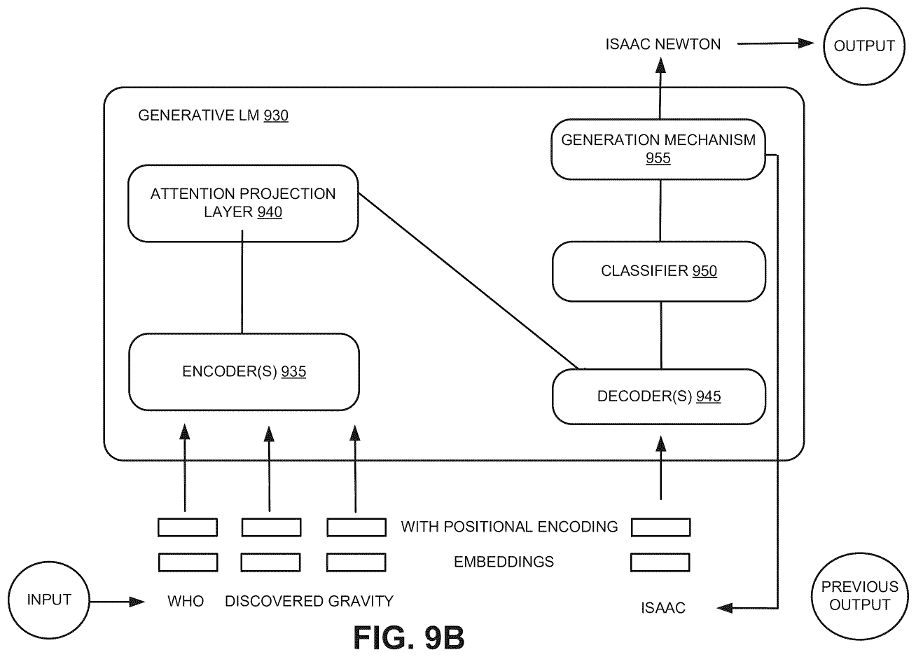

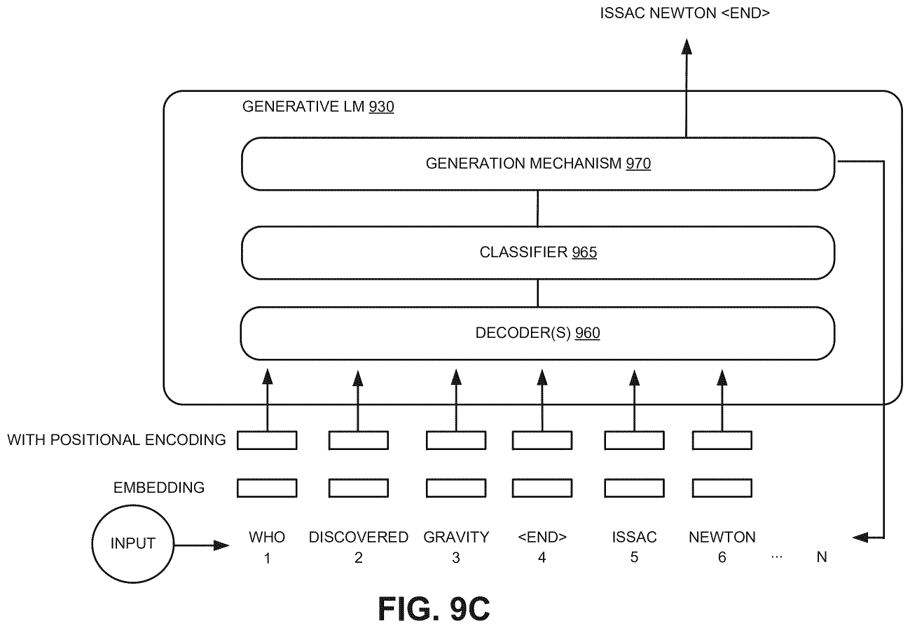

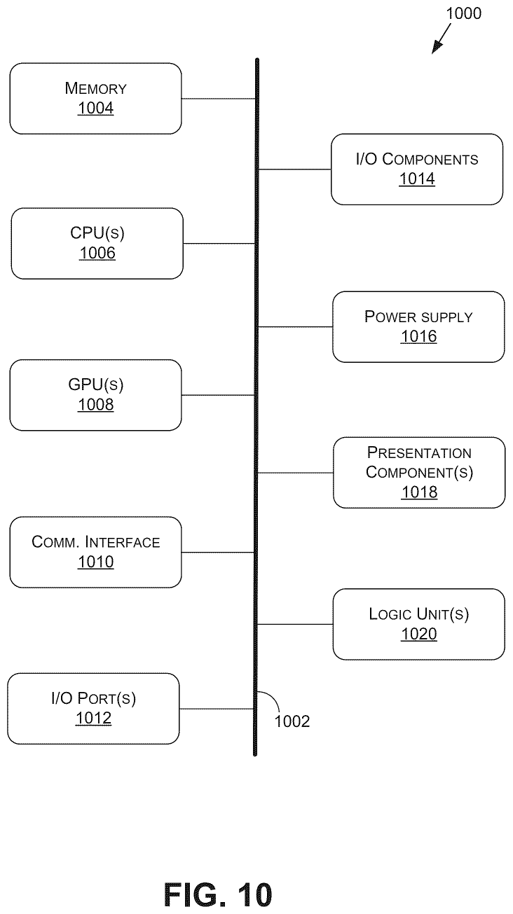

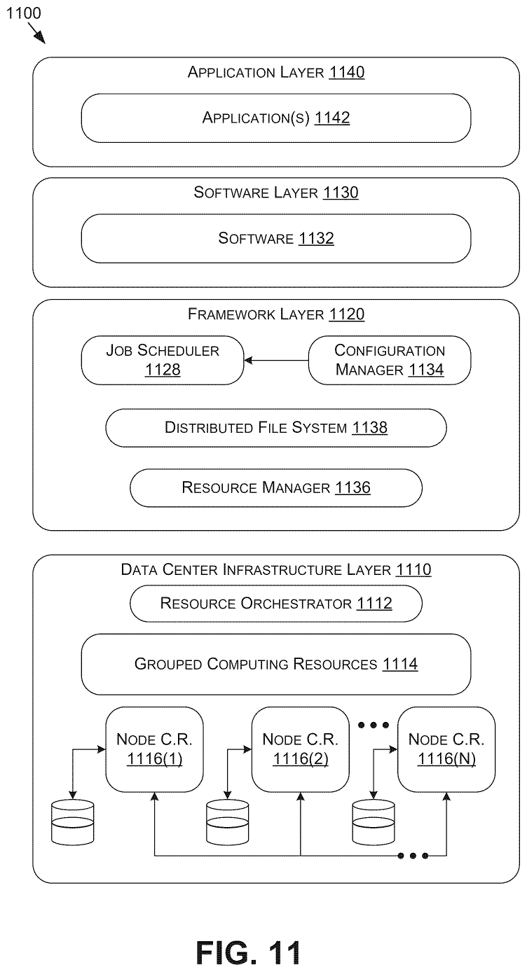

With reference to FIG. 1, FIG. 1 illustrates a block diagram illustrating an example system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

The system 100 may implement an automated test generation system and/or may otherwise be used to perform automated test generation using neural networks. The system 100 may generate test cases by analyzing one or more CLs and using one or more neural networks to extract semantic and functional insights from code modification data included in and/or extracted from the CL(s).

The system 100 includes a computing system 102 that may include one or more processors 104, storage 108, a user interface 110, and memory 112 connected to one another by one or more connections 122. The processor(s) 104 may be responsible for executing instructions 114 and/or managing the overall operation of the computing system 102. In at least one embodiment, the processor(s) 104 may include one or more central processing units (CPUs) and/or specialized processing units such as one or more parallel processing units (PPU(s)) 106, optimized for handling neural network operations. The processor(s) 104 may include one or more circuits that perform at least a portion of the instructions 114 stored in the memory 112. The processor(s) 104 may include the PPU(s) 106, such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel. The processor(s) 104 may be implemented, for example, using a main CPU complex, one or more microprocessors, one or more microcontrollers, the PPU(s) 106 (e.g., GPU(s)), one or more data processing units (“DPU(s)”), one or more arithmetic logic units (“ALU(s)”), and/or the like. In at least one embodiment, at least a portion of at least one of the processor(s) 104 is used to implement at least a portion of any system(s) depicted in and/or described with respect to FIGS. 9A-11. In at least one embodiment, at least a portion of at least one of the processor(s) 104 is implemented using at least a portion of any system(s) depicted in and/or described with respect to FIGS. 9A-11.

In at least one embodiment, the computer system 102 includes and/or has access to the storage 108 that provides persistent storage for data and/or instructions used by the computing system 102. The storage 108 may include various forms of non-volatile memory, such as one or more solid-state drives (SSDs), one or more hard disk drives (HDDs), and/or others.

The user interface 110 may facilitate interaction between users and the computing system 102. The user interface 110 may include input devices (e.g., keyboard, mouse) and output devices (e.g., display screen) to allow users to input data and receive feedback from the computing system 102. The user interface 110 may include a display device (not shown) that a user may use to view information generated and/or displayed by the computing system 102. The user may use the user interface 110 to enter user input (e.g., one or more prompts) into the computing system 102. The user interface 110 may communicate (e.g., wirelessly) with a user device (e.g., a cellular telephone, a laptop computer, a tablet, and/or the like) and may receive user input from the user device.

The memory 112 may store the instructions 114 and/or various functionalities required for the operation of the system 100. By way of additional non-limiting examples, the memory 112 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). In at least one embodiment, at least a portion of the memory 112 implements at least a portion of any system(s) depicted in and/or described with respect to FIGS. 9A-11. In at least one embodiment, at least a portion of the memory 112 uses at least a portion of any system(s) depicted in and/or described with respect to FIGS. 9A-11.

The memory 112 (e.g., one or more non-transitory processor-readable medium) may store the processor executable instructions 114 that when executed by the processor(s) 104 implement change list analysis functionality 116, test case generation functionality 118, abstract syntax tree generation functionality 120, and/or other functionality(ies) such as that described herein. The change list analysis functionality 116 analyzes CLs to identify code modifications and extract relevant insights, such as the type of change, impact on APIs, performance implications, and/or others. The test case generation functionality 118 generates new test cases based on the insights extracted from the CLs. The test case generation functionality 118 may utilize one or more neural networks to create test cases that adequately test new code features. The abstract syntax tree generation functionality 120 generates a condensed abstract syntax tree (AST) representation of the code that focuses on the modified portions identified in the CLs. The condensed AST provides information, such as function definitions, arguments, return types, and/or other types of information, enabling the neural network(s) to generate relevant test cases without accessing the entire codebase.

The connection(s) 122 (e.g., one or more buses) may facilitate communication between the processor(s) 104, the storage 108, the user interface 110, and the memory 112. The connection(s) 122 may be implemented using one or more buses, one or more Peripheral Component Interconnect Express (“PCIe”) connections (or bus(es)), and/or the like. The system 100 may be designed to automate the test generation process, and may reduce manual effort by using one or more neural networks to analyze code changes and generate test cases from extracted insights obtained from the code changes.

In at least one embodiment, the system 100 receives, as data inputs, change list data 124, codebase data 126, and/or test case source data 128, and outputs test cases data 130. The change list data 124 includes one or more CLs that identify code modifications to be analyzed by the system 100 (e.g., by the change list analysis functionality 116). The codebase data 126 includes the codebase and/or information that the system 100 may use to access a codebase, allowing the system 100 (e.g., the abstract syntax tree generation functionality 120) to generate ASTs and/or allowing the system 100 (e.g., the change list analysis functionality 116) to analyze code changes. The test case source data 128 includes existing test cases and/or information the system 100 may use to access the existing test cases (e.g., which may be stored in a database). The system 100 (e.g., the test case generation functionality 118) may search the existing test cases to find relevant test cases that the system 100 may be use and/or modify to test new code features (e.g., identified by the change list analysis functionality 116). The test cases data 130 output by the system 100 (e.g., the test case generation functionality 118) represents generated new test cases, which the system 100 may compile and/or store (e.g., in the storage 108) for future use.

When implementing the automated test generation system described herein, the system 100 may implement and/or use one or more language models 140 (e.g., LLM(s), SLM(s), VLM(s), MMLM(s), MLLM(s), etc.). For example, the change list analysis functionality 116 (e.g., performed by the processor(s) 104) may obtain first output 142 by providing the change list data 124 to one or more first language models 144 along with one or more first prompts (e.g., automatically generated by the change list analysis functionality 116). The first prompt(s) may request that the first language model(s) 144 generate first information describing the change(s) made to the codebase (e.g., kind(s) or type(s) of change(s), and/or other types of information) based upon the CL(s) included in the change list data 124. By way of a non-limiting example, the first language model(s) 144 may generate a separate instance of the first output 142 for each change described in the CL(s) included in the change list data 124. By way of another non-limiting example, the first language model(s) 144 may generate an instance of the first output 142 for more than one change described in the CL(s) included in the change list data 124. For example, a single instance of the first output 142 may be generated for the change list data 124.

The abstract syntax tree generation functionality 120 uses the codebase data 126 and the change list data 124 to generate an AST 146 that may represent only portions of the codebase that have changed. The abstract syntax tree generation functionality 120 may generate the AST concurrently with the change list analysis functionality 116 generating the first output 142.

The change list analysis functionality 116 (e.g., performed by the processor(s) 104) may use the AST to enhance the first output. For example, the change list analysis functionality 116 (e.g., performed by the processor(s) 104) may generate second output 148 by providing the first output 142 from the first language model(s) 144 and the AST 146 produced by the abstract syntax tree generation functionality 120 (e.g., performed by the processor(s) 104) to one or more second language models 150 along with one or more second prompts (e.g., automatically generated by the change list analysis functionality 116). The second prompt(s) may request(s) that the second language model(s) 150 generate second (e.g., refined) information describing the change(s) made to the codebase (e.g., kind(s) or type(s) of change(s), impact(s) on one or more APIs, performance implications, and/or others). The change list analysis functionality 116 may summarize the second output 148, for example, by providing the second output 148 to one or more language models along with a prompt requesting that the language model(s) summarize the second output 148.

The test case generation functionality 118 (e.g., performed by the processor(s) 104) may use the second output 148 (summarized or not) and the test case source data 128 to obtain a set 152 of candidate test cases. For example, the test case generation functionality 118 may perform a generative process 154 (e.g., Retrieval-Augmented Generation (RAG)) that includes a retrieval process 156 and one or more third language models 158. The test case generation functionality 118 (e.g., performed by the processor(s) 104) performs the retrieval process 156 based at least part on the second output 148 of the second language model(s) 150 (summarized or not) to identity any existing test cases in the corpus of existing test cases (e.g., included in or accessible using the test case source data 128). For example, the test case generation functionality 118 may provide the second output 148 (summarized or not) to the retrieval process 156, which may generate one or more queries, and use the query(ies) to search (e.g., a database) for existing test cases relevant to testing code for the change(s) described in the second output 148 (e.g., kind(s) or type(s) of change(s), impact(s) on one or more APIs, performance implications, and/or others). The retrieval process 156 may be implemented by one or more neural networks, such as one or more Bidirectional Encoder Representations from Transformers (BERT), one or more other transformer-based architectures, and/or one or more neural network that may be used to encode the query(ies) and each of the existing test cases into dense vector representations. The retrieval process 156 may use similarity between these vectors to retrieve relevant test cases. If appropriate, the second output 148 (summarized or not) may include a prompt to be used by the retrieval process 156. By way of another non-limiting example, the test case generation functionality 118 may generate one or more prompts to be input into the retrieval process 156. The retrieval process 156 outputs a set 160 of existing test cases.

Then, the test case generation functionality 118 provides the set 160 of existing test cases and the second output 148 (summarized or not) along with one or more third prompts to the third language model(s) 158 as input, and the third language model(s) 158 generate the set 152 of candidate test cases as output. The second output 148 (summarized or not) may include the third prompt(s) to be used by the third language model(s) 158. By way of another non-limiting example, the test case generation functionality 118 may generate the third prompt(s).

The test case generation functionality 118 (e.g., performed by the processor(s) 104) may provide the set 152 of candidate test cases and the second output 148 (summarized or not) to one or more fourth language models 162 along with one or more fourth prompts (e.g., automatically generated by the test case generation functionality 118). The fourth prompt(s) request that the fourth language model(s) 162 indicate whether each candidate test case in the set 152 of candidate test cases is capable of testing for the change(s) (e.g., desired change(s)) described in the second output 148 (e.g., kind(s) or type(s) of change(s), impact(s) on one or more APIs, performance implications, and/or others). For example, the fourth language model(s) 162 may output “YES,” if the fourth language model(s) 162 determines a particular candidate test case is capable of testing for one or more of the change(s) described in the second output 148 (referred to as a “valid test case”), and “NO” otherwise (referred to as an “invalid test case”). The fourth language model(s) 162 may evaluate each of the candidate test cases with respect to each change to the codebase described in the second output 148.

The test case generation functionality 118 may determine for which of the changes adequate valid test cases have been identified, and/or for which of the changes inadequate valid test cases have been identified. For example, for each change, the test case generation functionality 118 may compare a number of valid test cases identified to a threshold number to determine whether adequate valid test cases have been identified. In FIG. 1, a flow 164 depicts test cases associated with change(s) for which adequate valid test cases have been identified, and a flow 165 depicts test cases associated with change(s) for which inadequate valid test cases have been identified.

For any of the changes for which adequate valid test cases have been identified (in flow 164), the test case generation functionality 118 (e.g., performed by the processor(s) 104) may add the candidate test cases determined to be valid by the fourth language model(s) 162 to the test case data 130, which may be performed against the codebase. In FIG. 1, the test case generation functionality 118 (e.g., performed by the processor(s) 104) may provide the adequate valid test cases to a generative process 170 (e.g., RAG).

On the other hand, for any of the changes for which inadequate valid test cases have been identified (in flow 165), a set 166 of additional test cases may be generated. For example, the test case generation functionality 118 (e.g., performed by the processor(s) 104) may obtain the set 166 of additional test cases by providing the set 152 of candidate test cases, and the second output 148 (summarized or not) to one or more fifth language models 168 along with one or more fifth prompts (e.g., automatically generated by the test case generation functionality 118). The fifth prompt(s) may instruct the fifth language model(s) 168 to use the set 152 of candidate test cases as context or examples, and generate a set 166 of additional test cases to test for one or more changes described in the second output 148. In at least one embodiment, the third language model(s) 158 is/are used, instead of the fifth language model(s) 168, to generate the set 166 of additional test cases and the fifth language model(s) 168 is/are omitted.

The test case generation functionality 118 (e.g., performed by the processor(s) 104) then determines whether each test case in the set 166 of additional test cases is valid. For example, the test case generation functionality 118 may provide the set 166 of additional test cases and the second output 148 (summarized or not) to one or more sixth language models 172 along with one or more sixth prompts (e.g., automatically generated by the test case generation functionality 118). The sixth prompt(s) request that the sixth language model(s) 172 indicate whether each additional test case in the set 166 of additional test cases is capable of testing for the change(s) (e.g., desired change(s)) described in the second output 148. In at least one embodiment, the fourth language model(s) 162 is/are used, instead of the sixth language model(s) 172, to determine which test cases are valid, and the sixth language model(s) 172 is/are omitted.

The test case generation functionality 118 may determine (e.g., using the threshold value) for which of the changes adequate valid test cases have been identified, and/or for which of the changes inadequate valid test cases have been identified. For any of the changes for which inadequate valid test cases have been identified and/or generated by the fifth language model(s) 168 and/or the third language model(s) 158, the test case generation functionality 118 may repeat using the fifth language model(s) 168 and/or the third language model(s) 158 to generate one or more sets of additional test cases as described herein until adequate test cases are obtained. In FIG. 1, a flow 167 depicts test cases associated with change(s) for which adequate valid test cases have been identified, and a flow 169 depicts test cases associated with change(s) for which inadequate valid test cases have been identified.

In at least one embodiment, the test cases (e.g., in flow 164 and/or 167) may not be in a format that can be performed by the system 100. For example, the test cases may be in a natural language format and/or pseudo code format. The test case generation functionality 118 (e.g., performed by the processor(s) 104) may use the generative process 170 (e.g., RAG) to convert the test cases into a format that is performable by the system 100. The generative process 170 may include a retrieval process 176 and one or more seventh language models 178. The test case generation functionality 118 (e.g., performed by the processor(s) 104) performs the retrieval process 176 based at least part on the test cases (e.g., in flow 164 and/or 167) to identity any existing documentation (e.g., API documentation for example stored in a database) that may be used as context or example by the seventh language model(s) 178 when generating code to be performed by the system 100. For example, the test case generation functionality 118 may provide the test cases to the retrieval process 176, which may generate one or more queries, and use the query(ies) to search (e.g., a database) for existing documentation relevant to generating code to implement the test cases. The retrieval process 176 may be implemented by one or more neural networks, such as those described with respect to the retrieval process 156, that may be used to encode the query(ies) and each item of existing documentation into dense vector representations. The retrieval process 176 may use similarity between these vectors to retrieve relevant items of documentation. By way of another non-limiting example, the test case generation functionality 118 may generate one or more prompts to be input into the retrieval process 176. The retrieval process 176 outputs a set 174 of documentation.

Then, the test case generation functionality 118 (e.g., performed by the processor(s) 104) provides the set 174 of documentation and the test cases (e.g., in flow 164 and/or 167) along with one or more seventh prompts to the seventh language model(s) 178 as input, and the seventh language model(s) 178 generate the set 175 of candidate test codes (e.g., executable code, scripts, etc.) as output. By way of a non-limiting example, the test case generation functionality 118 may generate the seventh prompt(s), which instruct the seventh language model(s) 178 to generate the set 175 of candidate test codes to perform or implement the test cases (e.g., in flow 164 and/or 167) using the set 174 of documentation as context and/or an example.

Before adding the test code to the test cases data 130, the test case generation functionality 118 may fine tune or refine the set 175 of candidate test codes. The test case generation functionality 118 may provide the set 175 of candidate test codes, the set 174 of documentation, and/or the test cases (e.g., in flow 164 and/or 167) along with one or more eighth prompts to one or more eighth language models 180 as input, and the eighth language model(s) 180 may generate a set 182 of test codes (e.g., executable code, scripts, etc.) as output. By way of a non-limiting example, the test case generation functionality 118 may generate the eighth prompt(s), which instruct the eighth language model(s) 180 to generate the set 182 of test codes to perform or implement the test cases (e.g., in flow 164 and/or 167) using the set 175 of candidate test codes and/or the set 174 of documentation as context and/or an example.

The test case generation functionality 118 (e.g., performed by the processor(s) 104) may store the set 182 of test codes output by the eighth language model(s) 180 in the test case data 130 and/or a test corpus (e.g., to a database or file). Finally, the test case generation functionality 118 may trigger a process to perform the set 182 of test codes output by the eighth language model(s) 180 to test the change(s) to the codebase identified in the change list data 124.

The language models 144, 150, 158, 162, 168, 172, 178, and 180 may be trained separately and/or independently to perform tasks described herein. While the language models 144, 150, 158, 162, 168, 172, 178, and 180 have been described as being separate or independent from one another, in at least one embodiment, two or more of these language models may be implemented as a single language model.

The system 100 (e.g., the test case generation functionality 118) may perform real-time adaptation of existing test cases based at least in part on code modifications identified by the system 100 (e.g., the change list analysis functionality 116) using one or more CLs, and may analyze multiple CLs simultaneously, without extensive code documentation. In at least one embodiment, the analysis of the CL(s) is provided by the computer system 102 to a user through the user interface 110.

In at least one embodiment, the following are examples of inputs to and outputs from the computer system 102, which may be provided through the user interface 110. The user may input change list data 124 in the form of a diff file that contains the differences between versions of a code file and the user may input a codebase data 126 by providing a path to a source code file as in the following example.
Input Diff file:
/ds_hackfest/ds_hackfest/langgraph_implementation/sample_cls/3213326/e5cddd4.diff
Input Code file:
/ds_hackfest/ds_hackfest/langgraph_implementation/sample_cls/3213326/deepstream_sink_bin_new.c

In response, the computer system 102 may output the following set of responses and information related to the analysis of inputted change list data 124 and codebase data 126.
CL summary Response: cl_summary_response:
On Tue, 17 Sep. 2024, USER made changes to [PATCH] deepstream/sdk: Adding compute-hw property for filesink.
Type of change: Feature addition
Line changes: The exact change is the addition of a single line of code in deepstream_sink_bin.c file:
g_object_set (G_OBJECT (bin->transform), “compute-hw”, config->compute_hw, NULL);
Code change: This code change adds a new property called “compute-hw” to the nvvideoconvert element in the encode_file_bin. This property is set to the value of config->compute_hw, which is likely a configuration option. The purpose of this change is to enable VIC (Video Image Composer) utilization on Jetson devices.
Impact on functionality: The addition of this property allows for better performance and utilization of VIC on Jetson devices when using the filesink element. However, it also requires setting the encoder type to SW (Software) along with setting this property to GPU. This change may impact the functionality of the code by altering the way video encoding is performed.
Risks and Edge Cases: Potential risks and edge cases that might be introduced by this code change include:
Incorrect configuration options: If the config->compute_hw value is not set correctly, it may lead to unexpected behavior or performance issues.
Incompatible hardware: This change is specific to Jetson devices, so it may not work as expected on other hardware platforms.
Interference with other components: The addition of this property may interfere with other components in the pipeline, such as the primary-gie, Tracker, and SGIEs groups, which need to be disabled for this change to take effect.
These risks and edge cases should be thoroughly tested to ensure that the code change works as expected.
AST processed successfully
Summary Enhanced with AST: Here are my responses:

### Code Change Description

The code change adds a new property called “compute-hw” to the nvvideoconvert element in the encode_file_bin. This property is set to the value of config->compute_hw, which is likely a configuration option.

### Impact on Functionality

This change allows for better performance and utilization of VIC (Video Image Composer) on Jetson devices when using the filesink element. However, it also requires setting the encoder type to SW (Software) along with setting this property to GPU, which may alter the way video encoding is performed.

### Testing Steps

Test that the “compute-hw” property is set correctly for the nvvideoconvert element.
Verify that the VIC utilization on Jetson devices improves when using the filesink element with this change.
Test that setting the encoder type to SW and the “compute-hw” property to GPU results in correct video encoding behavior.

### Edge Cases

Incorrect configuration options: If the config->compute_hw value is not set correctly, it may lead to unexpected behavior or performance issues.
Incompatible hardware: This change is specific to Jetson devices, so it may not work as expected on other hardware platforms.
Interference with other components: The addition of this property may interfere with other components in the pipeline.

### Information Sufficiency

The provided information is sufficient for analyzing the impact and testing the modified lines. However, having the complete function definition would be helpful to understand the broader context and potential interactions with other parts of the code.
List of Test Templates found in Devtest: [‘83563’, ‘83563’, ‘83562’, ‘83562’]
   The preceding output is an example report output by the automated test generation system (e.g., implemented by the system 100). The CL summary response (above) displays the code changes made by a developer. In the above example, these changes enable Video Image Composer (VIC) utilization on Jetson devices. The report outlines the impact on functionality, indicating that it requires encoder settings that may alter video encoding behavior. The example report also identifies potential risks and edge cases, such as incorrect configuration options and hardware incompatibility. The report concludes with the test cases data 130 in the form of a list of test templates found in and/or retrieved from the test case source data 128.

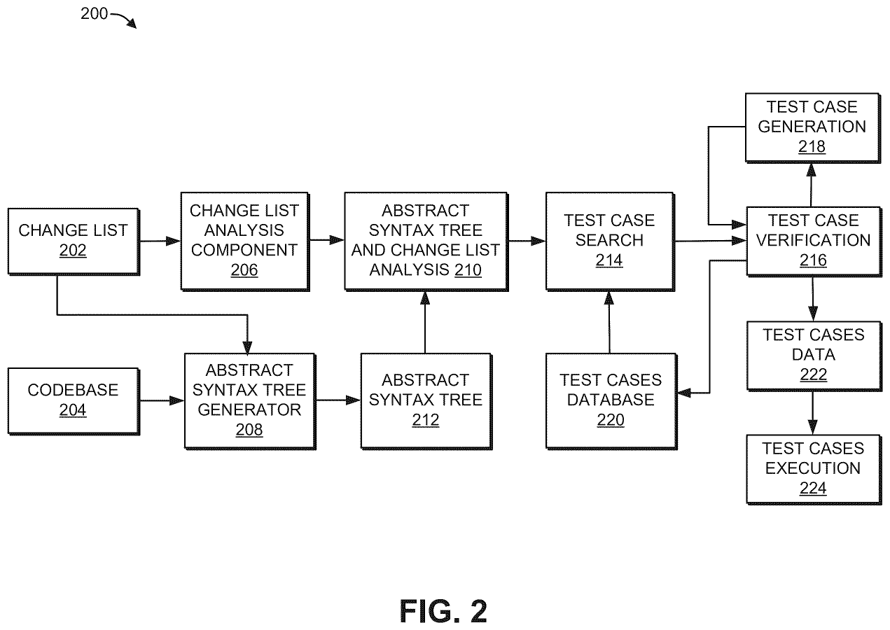

FIG. 2 illustrates a block diagram illustrating an automated test generation process 200, according to at least one embodiment. FIG. 2 provides an example illustration of the interactions between various components involved in the system 100, facilitating the generation of test cases (e.g., in flow 164 and/or 167) and/or test codes (e.g., the set 182 of test codes) from one or more CL(s) and codebase data. The automated test generation process 200 may be performed by the system 100. For example, the processor(s) 104 may use the change list analysis functionality 116, the test case generation functionality 118, and/or the abstract syntax tree generation functionality 120 (see FIG. 1) to perform the automated test generation process 200.

The automated test generation process 200 begins with a change list analysis component 206 obtaining, as input, a change list 202 (e.g., in the change list data 124), which contains information about code modifications to one or more codebases. The change list 202 is analyzed by the change list analysis component 206 (e.g., implemented at least in part by the change list analysis functionality 116), which extracts insights (e.g., semantic and/or functional) from the code changes contained in the change list 202. These insights may include the type of change, its impact on APIs, potential performance implications, and/or one or more others. In at least one embodiment, the change list analysis component 206 includes one or more neural networks (e.g., the first language model(s) 144 and/or the second language model(s) 150) trained to extract semantic and functional features from the code changes contained in change lists.

The automated test generation process 200 may include an abstract syntax tree generator 208 obtaining, as input, the codebase 204 and the change list 202. The codebase 204 implements one or more software programs that is/are to undergo changes and/or modifications detailed in the change list 202. In at least one embodiment, the abstract syntax tree generator 208 (e.g., implemented at least in part by the abstract syntax tree generation functionality 120) uses at least the codebase 204 to generate an Abstract Syntax Tree (AST) 212. The AST 212 provides a condensed representation of the codebase 204, focused on the modified portions identified in the change list 202. The condensed AST representation can include function definitions, arguments, return types, and/or other information, which can be used to generate test cases and/or the test code (e.g., to be included in the test cases data 130).

The automated test generation process 200 may include an abstract syntax tree and change list analysis component 210 obtaining output from the change list analysis component 206 (e.g., insights) and the AST 212 as input. The abstract syntax tree and change list analysis component 210 (e.g., implemented at least in part by the test case generation functionality 118) synthesizes the AST 212 and the insights from the change list analysis component 206 to generate one or more identifications of one or more code modifications contained in the change list 202 and implications associated with the code modification(s). In at least one embodiment, the abstract syntax tree and change list analysis component 210 includes one or more neural networks (e.g., the language models 158, 162, 168, 172, 178, and/or 180) trained to identify code modifications contained in one or more change lists (e.g., the change list 202) using one or more ASTs (e.g., the AST 212) and the change list(s) as input.

A generative process (e.g., the generative process 154) may use the inferred insights generated by the abstract syntax tree and change list analysis component 210 to perform a test case search 214 in a test cases database 220 or other type of data store. The test cases database 220 may store a corpus of pre-validated test cases and/or test codes generated for the codebase 204 and/or other codebases. The test case search 214 seeks to identify existing test cases that may be relevant to the new code features. If suitable test cases are found, they are retrieved. The generative process (e.g., the third language model(s) 158) may use the existing test cases identified by the test case search 214 as examples or context, and may generate a set of candidate test cases (e.g., the set 152 of candidate test cases).

In cases where existing test cases retrieved and/or new test cases are generated are insufficient or non-existent, the automated test generation process 200 proceeds to a test case generation component 218 (e.g., implemented at least in part by the test case generation functionality 118). The test case generation component 218 utilizes one or more neural networks (e.g., the fifth language model(s) 168 and/or the sixth language model(s) 172) to generate new test cases based at least in part on the insights extracted from the change list 202 and the AST 212. The generated test cases may be designed to adequately test the new code features.

Once test cases are generated or retrieved, they undergo test case verification 216 (e.g., implemented at least in part by the test case generation functionality 118). Test case verification 216 of the automated test generation process 200 involves validating the test cases to ensure they effectively test the intended code modifications. The test case verification 216 may include checking for semantic and functional accuracy, as well as performance validation. When generated test cases fail verification, the test case generation functionality 118 may provide the failed test cases back to the test case generation component 218 for refinement. When generated test cases are determined to be suitable, the test case generation functionality 118 may add the newly generated test cases to the test case database 220 (e.g., for use in the future).

The test case generation functionality 118 may compile the verified test cases into test cases data 222 (e.g., the test case data 130), which may be stored for future use. This test cases data 222 may serve as a repository of validated test cases that can be executed or otherwise used to test the code modifications. Finally, the test cases execution component 224 executes or otherwise uses the test cases to test whether the changes made to the codebase 204 and identified in the change list 202 produce desired effects. This execution process involves running the test cases against modified code in the codebase 204 to verify that the changes produce the desired effects. The results of the test execution are used to assess the correctness and performance of the code modifications.

In at least one embodiment, the automated test generation process 200 is performed by the computing system 102 of FIG. 1. In FIG. 2, the change list analysis component 206 in FIG. 2 corresponds to and may be performed by using the change list analysis functionality 116 in FIG. 1 to extract insights from code modifications. In FIG. 2, the abstract syntax tree generator 208 in FIG. 2 corresponds to and may be performed by using the AST generation functionality 120 in FIG. 1, that creates a representation of the codebase. The test case generation component 218 in FIG. 2 corresponds to and may be performed by using the test case generation functionality 118 in FIG. 1, to generate and verifying test cases. In at least one embodiment, any of the components of FIG. 2 may be implemented in at least a portion of any system(s) depicted in and/or described with respect to FIGS. 9A-11.

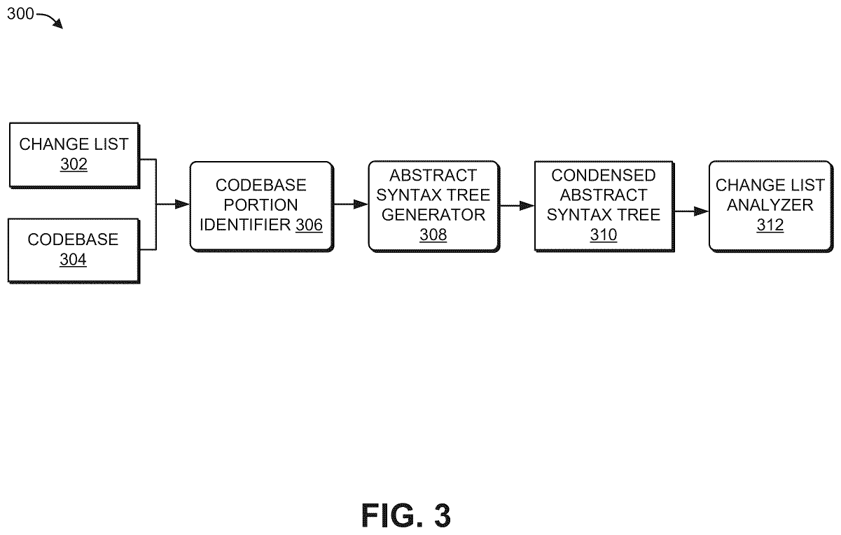

FIG. 3 illustrates a block diagram of a system 300 for generating a condensed abstract syntax tree (AST) from a change list (CL) and a codebase, according to at least one embodiment. FIG. 3 illustrates components and steps involved in transforming code modifications into a format suitable for automated test generation. The system 300 may be implemented at least in part by the system 100. The abstract syntax tree generation functionality 120 may be used to implement at least a portion of the system 300.

The system 300 includes a codebase portion identifier 306, an abstract syntax tree generator 308, and a change list analyzer 312. The codebase portion identifier 306 receives, as input, a change list 302 and a codebase 304 associated with the change list 302. The change list 302 contains information about specific code modifications, while the codebase 304 provides access to a code repository. These inputs are to be used by the codebase portion identifier 306 to identify the portions of the code that have been modified and require testing.

The codebase portion identifier 306 analyzes the change list 302 to determine which portions of the codebase 304 have been affected by the modifications. This identification is used to focus the subsequent analysis on relevant sections of the code, thereby optimizing the efficiency of the test generation process.

Once the relevant code portion(s) is/are identified, the abstract syntax tree generator 308 (e.g., the abstract syntax tree generator 208) creates a condensed abstract syntax tree (AST) 310 for the code portion(s) identified by the codebase portion identifier 306. The condensed AST 310 provides a structured representation of the code, capturing essential elements such as function definitions, arguments, return types, and/or others. By focusing on the relevant portions of the code and condensing the AST, there is a reduced need for extensive code documentation in the test generation process. Further, one or more the neural networks used to generate the test cases based on the change list 302 (e.g., the language models 144, 150, 158, 162, 168, 172, 178, and 180) do not need to access the codebase 304, and security is improved because the condensed AST 310 to which at least some of these neural network(s) have access includes less than the entire codebase.

The condensed AST 310 is subsequently analyzed by the change list analyzer 312. The change list analyzer 312 utilizes neural networks to extract semantic and functional insights from the condensed AST. These insights include the type of change, its impact on APIs, and potential performance implications, which are crucial for generating relevant and effective test cases.

In at least one embodiment, the system 300 is implemented at least in part by the computing system 102 of FIG. 1 and/or in connection with the automated test generation process 200 of FIG. 2. In at least one embodiment, any of the components of FIG. 3 may be implemented in at least a portion of any system(s) depicted in and/or described with respect to FIGS. 9A-11.

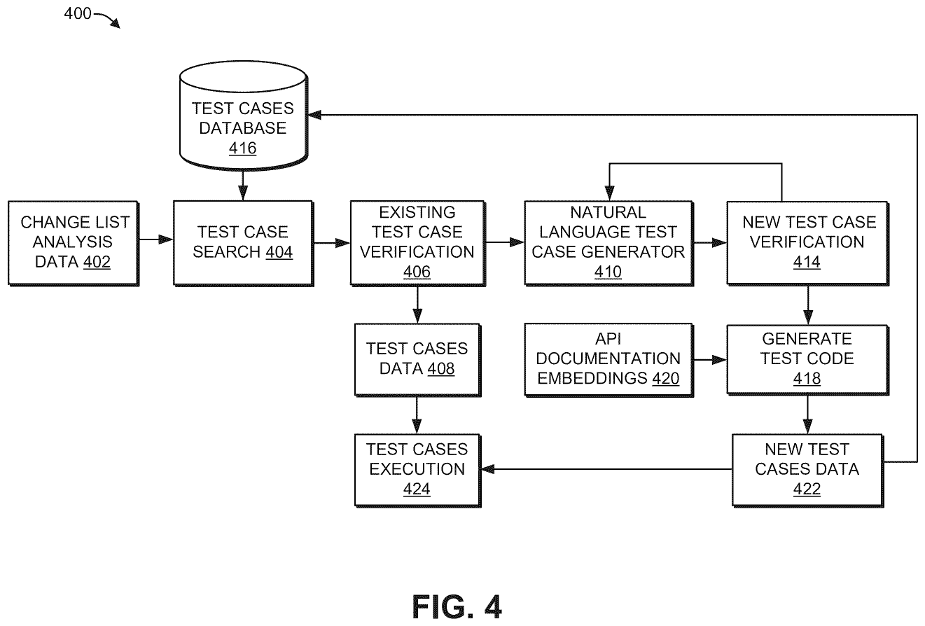

FIG. 4 illustrates a block diagram of a system 400 to perform a test case generation and verification process, according to at least one embodiment. FIG. 4 illustrates an example view of the components and interactions involved in generating, verifying, and/or executing test cases using one or more neural networks and change list analysis data 402.

The system 400 receives change list analysis data 402 (e.g., from a user via the user interface 110 and/or from an automated process), which contains insights extracted from code modifications (e.g., described in one or more CLs). The system 400 uses the change list analysis data 402 to initiate a test case search 404 within a test cases database 416. The search is to identify any existing test cases that may be relevant to the new code features identified in the CLs.

The system 400 may perform existing test case verification 406 with respect to any test cases identified by the test case search 404. The existing test case verification 406 involves validating the test cases to ensure they effectively test the intended code modifications. The existing test case verification 406 checks for semantic and functional accuracy, as well as performance validation. Verified test cases may be compiled into test cases data 408.

If existing test cases are insufficient or non-existent, the system 400 uses a natural language test case generator 410. The natural language test case generator 410 utilizes one or more neural networks to generate new test cases based on the insights extracted from the CLs.

The system 400 performs new test case verification 414 with respect to newly generated test cases. Similar to the existing test case verification 406, the new test case verification 414 ensures that the new test cases are valid and capable of testing the intended code modifications. Verified new test cases are then compiled by a generate test code process 418 performed by the system 400 into new test cases data 422. In at least one embodiment, API Documentation Embeddings 420 are used to assist in with the generate test code process 418. The API Documentation Embeddings 420 are derived from project-specific documentation and/or API guides. Additionally, the system 400 adds new verified test cases data 422 to the test cases database 416 for future use.

Once test cases are verified, the system 400 may cause the test cases to be performed using a test cases execution component 424, The test cases execution component 424 may be component of the system 400 and/or another system external to but accessible by the system 400. The test cases execution component 424 may run the test cases against the modified code to verify that the changes produce the desired effects. The system 400 may use the results of the test execution to assess the correctness and performance of the code modifications.

In at least one embodiment, the system 400 is performed by the computing system 102 of FIG. 1 and/or in connection with the automated test generation process 200 of FIG. 2, and system 300 of FIG. 3. In at least one embodiment, any of the components of FIG. 4 may be implemented in at least a portion of any system(s) depicted in and/or described with respect to FIGS. 9A-11.

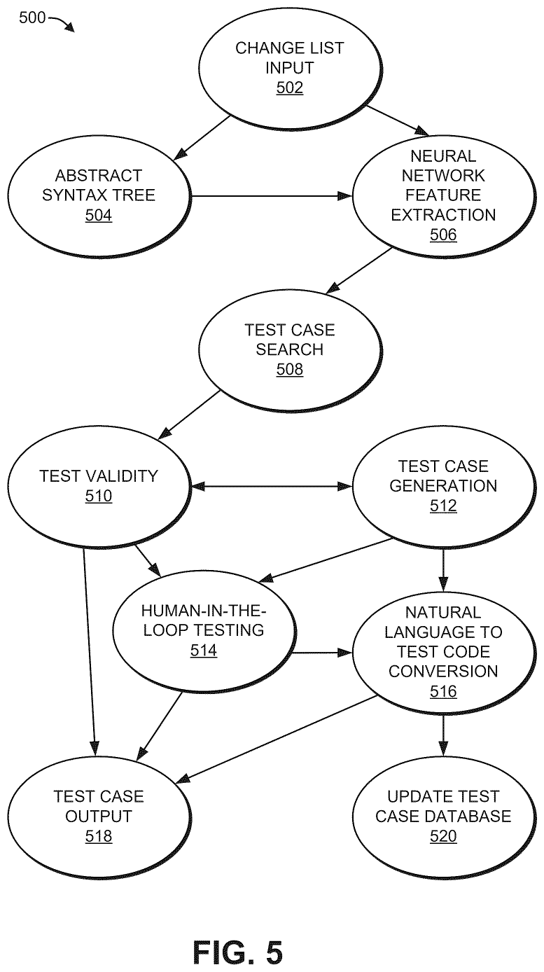

FIG. 5 illustrates a graph 500 depicting a process of automated test generation and validation using one or more neural networks, according to at least one embodiment. FIG. 5 illustrates an executable directed acyclic graph (DAG) representation of sequential and/or iterative steps involved in transforming change list inputs into validated test cases, ready for execution. Each node in the graph 500 may be an executable portion of code to perform a designated function. Node 506 may be implemented at least in part by the change list analysis functionality 116. A node 504 represents an AST, which may be generated at least in part by the abstract syntax tree generation functionality 120. Any or all of nodes 508-520 may be implemented at least in part by the test case generation functionality 118.

The first node 502 of the graph 500 represents change list input, which serves as the primary source of information regarding code modifications. The change list input represented by the node 502 is used for identifying specific changes that need to be tested.

The second node 504 represents an AST generated from the codebase, focusing on the modified portions identified in the change list input represented by the first node 502. The AST provides a structured representation of the code, capturing elements such as function definitions, arguments, return types, and/or others.

The third node 506 represents neural network feature extraction. Simultaneous with generation of the AST represented by the second node 504, neural network feature extraction (e.g., performed by the change list analysis functionality 116) analyzes the change list input represented by the first node 502 to extract semantic and functional insights. These insights include the type of change, its impact on APIs, potential performance implications, and/or others.

The AST (represented by the node 504) and outputs from the neural network feature extraction (represented by the node 506) are provided to the node 508 that represents test case search. The test case search (represented by the node 508) searches existing test cases (e.g., stored in a test cases database) to identify any that may be relevant to the new code features. If suitable test cases are found, they are retrieved for further analysis.

The node 510 represents test validity assessment performed with respect to retrieved test cases. The test validity assessment (represented by the node 510) validates the test cases to ensure they effectively test the intended code modifications. The validation process checks for semantic and functional accuracy, as well as performance validation.

The node 512 represents test case generation. In cases where existing test cases are insufficient or non-existent, test case generation utilizes natural language neural networks to generate new test cases based on the insights extracted from the change list input (represented by the first node 502) and the AST (represented by the node 504). The generated test cases may be designed to adequately test the new code features, ensuring comprehensive coverage.

The node 516 represents test code conversion. The newly generated test cases are converted from natural language descriptions into executable test code through the natural language to test code conversion (represented by the node 516). This conversion may use embeddings from project-specific documentation, API guides, and/or other sources of information.

The node 514 represents Human-in-the-Loop Testing. The Human-in-the-Loop Testing (represented by the node 514) may enhance the accuracy and reliability of the test generation process. Human intervention can be introduced at various stages to review and refine the generated test cases, ensuring they meet the desired quality standards. By way of non-limiting examples, human intervention can be introduced between node 510 and node 516, between node 510 and node 518, between node 512 and node 516, and/or between node 512 and node 518. After each node processes its task, the output of the node can be reviewed by a human to ensure it is accurate and sufficient before proceeding to the next node.

The node 518 represents test case output, which may include one or more test cases and/or test code. Once test cases are validated, they are compiled into the test case output, which is stored for future use. This output may serve as a repository of validated test cases that can be executed to test the code modifications. The node 520 represents an update a test case database process. The newly generated and validated test cases may be added to a test case database by the update test case database process (represented by the node 520).

In at least one embodiment, the graph 500 is performed by the computing system 102 of FIG. 1 and/or in connection with the automated test generation process 200 of FIG. 2, the system 300 of FIG. 3, and/or the system 400 of FIG. 4. In at least one embodiment, any of the components of FIG. 5 may be implemented in at least a portion of any system(s) depicted in and/or described with respect to FIGS. 9A-11.

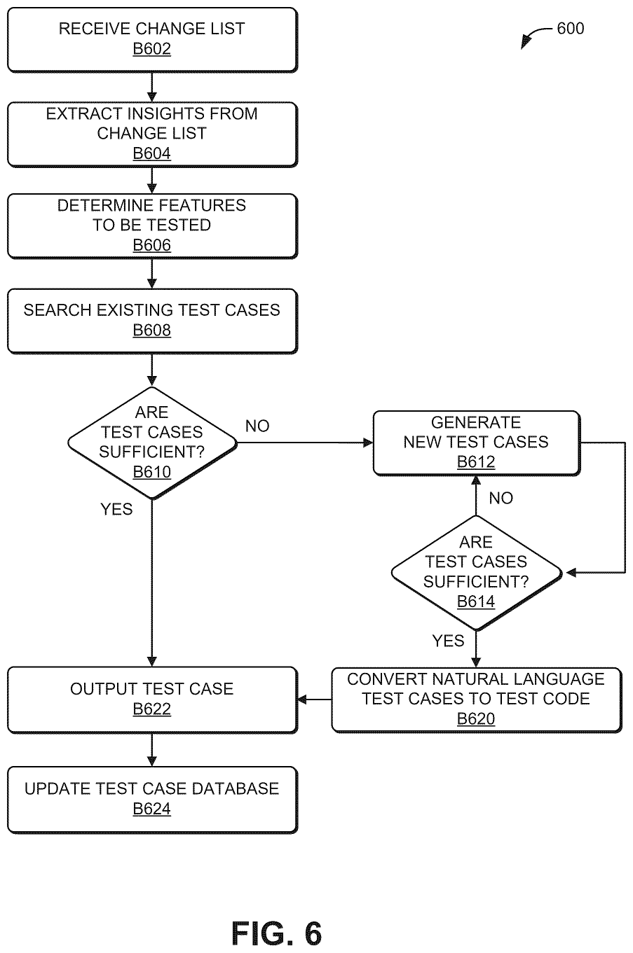

Now referring to FIG. 6, each block of a method 600, described herein, includes a computing process that may be performed using any combination of hardware, firmware, and/or software. For instance, various functions may be carried out using one or more processors executing instructions stored in one or more memories. The method 600 may also be embodied as computer-usable instructions stored on computer storage media. The method 600 may be provided by a standalone application, a service or hosted service (standalone or in combination with another hosted service), as a microservice via an application programming interface (API) or a plug-in to another product, to name a few. In addition, the method 600 is described, by way of example, with respect to the system 100 of FIG. 1. However, this method 600 may additionally or alternatively be executed by any one system, or any combination of systems, including, but not limited to, those described herein.

FIG. 6 is a flow diagram illustrating the method 600 for automated test generation, in accordance with some embodiments of the present disclosure. This method 600 outlines at least one embodiment of sequential steps involved in transforming change list inputs into validated and executable test cases. For ease of illustration, the method 600 will be described as being performed by the system 100 (see FIG. 1). However, the method 600 may be performed by another system, such as any of the systems described herein.

The method 600, at block B602, begins with the system 100 obtaining input in the form of a change list (e.g., included in the change list data 124). This change list identifies and/or contains information about specific code modifications to be tested.

Next, the method 600, at block B604, includes utilizing one or more neural networks (e.g., the first language model(s) 144) to extract semantic and/or functional insights (e.g., the first output 142) from the code modifications identified in the change list. These insights include the type of change, and/or others.

The method 600, at block B606, includes determining information (e.g., features) describing change(s) made to the codebase (e.g., kind(s) or type(s) of change(s), impact(s) on one or more APIs, performance implications, and/or others) that is/are to be tested. At block B606, the method 600 may include obtaining an AST (e.g., the AST 146) representing the codebase (e.g., included in or accessible using the codebase data 126), and determining the information using the AST and the insights extracted from the code changes at B604. At block B606, the method 600 may include using one or more neural networks (e.g., the second language model(s) 150) to determine the information (e.g., the second output 148), which may identify and/or describe new code features to be tested. The information determined at B606 may include kind(s) or type(s) of change(s), impact(s) on one or more APIs, performance implications, and/or other information.

The method 600, at block B608, includes searching existing test cases. This may involve querying a database of existing test cases to identify any that may be relevant to the new code features identified in block B604 and/or B606. The goal is to find test cases that can adequately validate the changes. The method 600, at block B608, may perform a retrieval process (e.g., the retrieval process 156 of the generative process 154) that uses the information (e.g., the second output 148) obtained at B606 to retrieve existing test cases (e.g., by querying a database), followed by one or more neural networks (e.g., the third language model(s) 158) that use any existing test cases retrieved by the retrieval process to generate test cases (e.g., the set 152 of candidate test cases).

The method 600, at decision block B610, includes determining whether the test cases generated at block B608 are sufficient. The decision at decision block B610 is “YES,” when the test cases generated at block B608 are sufficient. Otherwise, the decision at decision block B610 is “NO.” At decision block B610, the method 600 may include using one or more neural networks (e.g., the fourth language model(s) 162) to determine which of the test cases generated at block B608 are valid (or is capable of testing for the change(s) described in the output of block B606), and determines whether a sufficient number of the test cases are valid. The method 600 may include validating each of the test cases generated at block B608, which may involve checking the test cases for semantic accuracy, checking the test cases for functional accuracy, validating performance of the test cases, and/or performing one or more other validation checks. The method 600 may include classifying each of the test cases as being valid or invalid. The method 600 may include determining whether a sufficient number of the test cases are valid by comparing the number of valid test cases to a threshold value. By way of a non-limiting example, the number of the valid test cases may be considered sufficient if the number of the valid test cases exceeds the threshold value.

If the decision at decision block B610 is “YES,” the method 600 advances to block B622. The method 600, at block B622, includes outputting the test cases (e.g., in the data flow 164). The method 600, at block B622, may include the system 100 compiling and/or storing the test cases for future use. In at least one embodiment, instead of advancing to block B622, the method 600 advances to block B620 if the decision at decision block B610 is “YES.”

If the decision at decision block B610 is “NO,” the test cases (e.g., in the data flow 165) generated at block B608 are insufficient or non-existent. When this is the case, the method 600, at block B612, includes generating new test cases. The method 600, at block B612, may include using one or more neural networks (e.g., the third language model(s) 158 and/or the fifth language model(s) 168) to create new test cases (e.g., the set 166 of additional test cases) based at least in part on the insights extracted from the change list and code analysis performed at block B606 (e.g., the second output 148), and/or the test cases (e.g., in the data flow 165) generated at block B608. For example, if a particular test case was determined to be invalid at decision block B610, the method 600 may include refining the particular test case based on feedback and re-evaluating its validity at decision block B614. By way of a non-limiting example, at block B612, the method 600 may include refining the particular test case by generating at least one prompt requesting one or more neural networks (e.g., the third language model(s) 158 and/or the fifth language model(s) 168) to generate one or more new test cases to test for the change(s) described in the output of block B606 (e.g., the second output 148) using the particular test case and/or one or more other test cases (e.g., valid test cases) as context or an example. The method 600 may include adding newly created test cases to any of the test cases found to be valid at decision block B610. Any of the test cases found to be invalid may be omitted and/or replaced with a refined test case. Thus, at this point, the method 600 may have produced a set of test cases (e.g., the set 166 of additional test cases and/or the test cases found to be valid at decision block B610).

The method 600, at decision block B614, includes determining whether the test cases output at block B612 are sufficient. The decision at decision block B614 is “YES,” when the test cases output at block B612 are sufficient. Otherwise, the decision at decision block B614 is “NO.” At decision block B614, the method 600 may include performing any of the operations described with respect to block B610. For example, the method 600 may include using one or more neural networks (e.g., the fourth language model(s) 162 and/or the sixth language model(s) 172) to determine which of the test cases output at block B612 are valid, and determining whether a sufficient number of the test cases are valid. The method 600 may include determining the validity for any of the test cases for which validity has not yet been determined. For example, if the output at block B612 includes any test cases already determined to be valid by the method 600 at block B610, the method 600 at block B614 may simply use that previous determination or may reevaluate such test case(s). The method 600 may use the threshold value to determine whether a sufficient number of valid test cases have been identified.

If the decision at decision block B614 is “YES,” the method 600 advances to block B620. At this point, the method 600 has produced a set of sufficient valid test cases. If the decision at decision block B614 is “NO,” the method 600 returns to block B612 to repeat generating new test cases. A loop including blocks B612 and B614 continues until a set of sufficient valid test cases is produced.

Once the set of valid test cases is obtained, the method 600, at block B620, converts the test cases (e.g., from natural language descriptions) into executable test code. By way of non-limiting example, the executable test code (e.g., the set 182 of test codes) may include source code, object code, one or more scripts, one or more macros, etc. This conversion may be facilitated by fine-tuned models that leverage embeddings from project-specific documentation, API guides, and/or one or more other sources of relevant information. The method 600, at block B620, may include using the generative process 170 (e.g., RAG) to convert the test cases into a format that is performable by the system 100, and the eighth language model(s) 180 may refine the output of the generative process 170. The method 600 may include providing the test cases to the retrieval process 176 of the generative process 170, which may generate one or more queries, and use the query(ies) to search (e.g., a database) for existing documentation relevant to generating code to implement the test cases. The retrieval process 176 outputs a set 174 of documentation. Then, the method 600 may include providing the set 174 of documentation and the test cases (e.g., in flow 164 and/or 167) to the seventh language model(s) 178 of the generative process 170 as input, and the seventh language model(s) 178 generate the set 175 of candidate test codes (e.g., executable code, scripts, etc.) as output. The method 600 may include instructing the seventh language model(s) 178 to generate the set 175 of candidate test codes to perform or implement the test cases (e.g., in flow 164 and/or 167) using the set 174 of documentation as context and/or an example. The method 600 may include providing the set 175 of candidate test codes, the set 174 of documentation, and/or the test cases (e.g., in flow 164 and/or 167) along with one or more eighth prompts to the eighth language model(s) 180 as input, and the eighth language model(s) 180 generate a set 182 of test codes (e.g., executable code, scripts, etc.) as output. By way of a non-limiting example, the method 600 may include generating the eighth prompt(s), which instruct(s) the eighth language model(s) 180 to generate the set 182 of test codes to perform or implement the test cases (e.g., in flow 164 and/or 167) using the set 175 of candidate test codes and/or the set 174 of documentation as context and/or an example.

The method 600, at block B622, may output the validated and converted test cases. In at least one embodiment, the method 600 may include compiling and/or storing such test cases in a repository ready for execution.

Finally, the method 600, at block B624, updates a test case database. Adding the newly generated and validated test cases to the database may help ensure that they are available for future reference and/or use.

In at least one embodiment, the method 600 is performed by the computing system 102 of FIG. 1 and/or in connection with the automated test generation process 200 of FIG. 2, the system 300 of FIG. 3, the system 400 of FIG. 4, and the graph 500. In at least one embodiment, any of the components of FIG. 6 may be implemented in at least a portion of any system(s) depicted in and/or described with respect to FIGS. 9A-11.

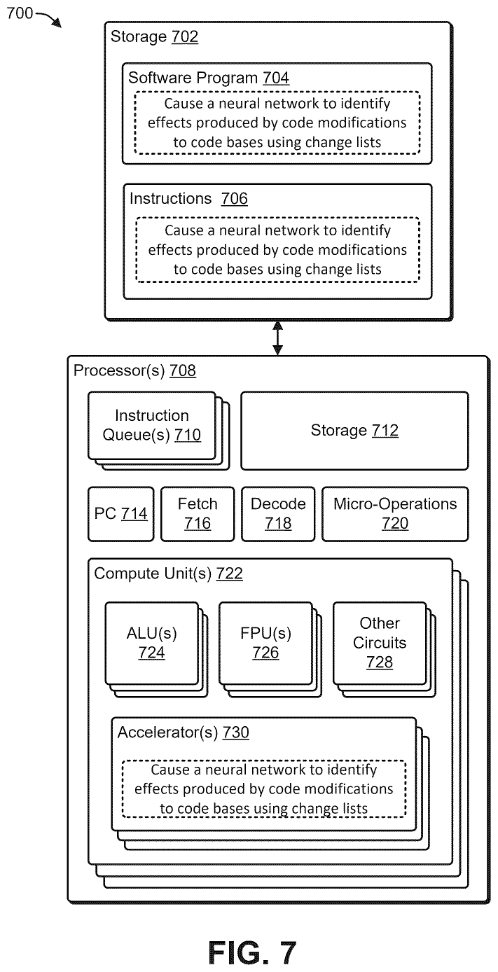

FIG. 7 illustrates an example of a system 700 that can include software and hardware to cause neural network(s) to identify effects produced by code modifications to codebases using change lists, automatically generate one or more test cases and/or test codes based at least in part on one or more change lists, and/or otherwise perform any of the operations described herein, according to at least one embodiment. System 700 can include storage 702 and processor(s) 708. Storage 702 can include, for example, memory, cache, or other storage described further herein. Storage 702 can be separate from processor(s) 708, or storage 702 can be included in processor(s) 708 (e.g., in storage 712). In at least one embodiment, software program 704 and/or software libraries (or instructions) 706 can be stored in memory, cache, or other storage and provided to processor(s) 708 to cause one or more circuits of processor(s) 708 to perform operations described herein. In at least one embodiment, software program 704 and/or software libraries (or instructions) 706 can be integrated into one or more circuits of processor(s) 708. Software program 704, which can be used to perform any of the operations described herein, may be stored on storage 702.

In at least one embodiment, software program 704 can include one or more software modules. In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 704 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. Instructions (e.g., hardware instructions) or microcode can involve ISA level instructions, which can include native ISA instructions or non-native ISA instructions. Software program 704 and/or software libraries (or instructions) 706 (e.g., one or more modules) can be distributed among multiple processors that communicate over a bus, network, by writing to shared memory, and/or any suitable communication process such as those described herein.

In at least one embodiment, system 700 can include one or more software libraries 706 that can, for example, provide one or more APIs and/or ISA instructions. In at least one embodiment, one or more APIs and/or ISA instructions can be used to cause neural network(s) to identify effects produced by code modifications to codebases using change lists, automatically generate one or more test cases and/or test codes based at least in part on one or more change lists, and/or otherwise perform any of the operations described herein. In at least one embodiment, one or more software libraries 706 can be included in drivers and/or runtimes. In at least one embodiment, software libraries 706 (e.g., including one or more APIs and/or ISA instructions) can include sets of software instructions that, if executed or otherwise performed, cause processor(s) 708 to perform one or more computational operations, such as any of the operations described herein. In at least one embodiment, one or more APIs and/or ISA instructions can be distributed or otherwise provided as a part of one or more software libraries 706, runtimes, drivers, and/or any other grouping of software and/or executable code further described herein. In at least one embodiment, one or more APIs and/or ISA instructions can perform one or more computational operations in response to invocation by software program 704.

Processor(s) 708 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 9-21. In at least one embodiment, processor(s) 708 can retrieve or fetch instructions (e.g., one or more APIs and/or ISA instructions) from storage 702 using, for example, instruction fetch 716 (e.g., for an Instruction Fetch stage). Instructions can include instructions to cause neural network(s) to identify effects produced by code modifications to codebases using change lists, automatically generate one or more test cases and/or test codes based at least in part on one or more change lists, and/or otherwise perform any of the operations described herein. In at least one embodiment, processor(s) 708 can include storage 712 and instruction queue 710 to store and queue instructions fetched from storage 702. In at least one embodiment, fetched instructions can be decoded by decode 718 to determine what operation should be performed by processor(s) 708 (e.g., in an Instruction Decode stage). In at least one embodiment, processor(s) 708 can fetch additional operands (data) that may be used for instructions, and operands can be stored, e.g., in registers or storage 712. In at least one embodiment, micro-operations 720 can perform operations on data stored in one or more registers or storage 712. For example, each step of instructions fetched by processor(s) 708 can be decomposed during execution so processor(s) 708 can execute instructions in steps through a series of micro-operations 720. In at least one embodiment, program counter (PC) 714 can hold an address for a next instruction and can be updated to point to the next instruction to be executed by processor(s) 708.

In at least one embodiment, processor(s) 708 can perform instructions (e.g., in an Execution stage). For example, processor(s) 708 can perform an operation specified by the instructions, such as an arithmetic operation, a logical operation, or a data transfer. In at least one embodiment, compute unit(s) 722 can execute instructions to perform any of the operations described herein. In at least one embodiment, compute unit(s) can include ALU(s) 724 (Arithmetic Logic Units), which may be used for performing arithmetic and logical operations. In at least one embodiment, compute unit(s) can include FPU(s) (Floating Point Units) 726, which may be used for performing floating-point calculations. In at least one embodiment, other circuits 728 can be used to perform other operations, such as vector and/or scalar operations. In at least one embodiment, accelerator(s) 730 can include one or more matrix multiplication accelerators, one or more parallel processing units (PPUs), such as GPUs, or any other accelerator or processor further described herein. In at least one embodiment, software program 704 can utilize one or more APIs and/or ISA instructions to perform various computing operations with accelerator(s) 730, such as matrix multiplication, arithmetic operations, or any other computing operation further described herein. In at least one embodiment, one or more computing operations using accelerator(s) 730 can include at least one or more groups of computing operations to be accelerated by execution at least in part by accelerator(s) 730, including to cause neural network(s) to identify effects produced by code modifications to codebases using change lists, automatically generate one or more test cases and/or test codes based at least in part on one or more change lists, and/or otherwise perform any of the operations described herein.

In at least one embodiment, system 700 can be used to perform one or more instructions that include functions or operations, such as those described in connection with FIGS. 1-6. In at least one embodiment, system 700 including one or more processors causes one or more circuits to generate at least one 3D segmentation mask of a 3D mesh of an object and/or otherwise perform operations described herein. In at least one embodiment, system 700 is included in and/or otherwise includes systems illustrated in FIGS. 1-6 to cause one or more circuits to generate at least one 3D segmentation mask of a 3D mesh of an object and/or otherwise perform operations described herein. In at least one embodiment, system 700 includes one or more hardware illustrated in FIGS. 9A-11 such as to generate at least one 3D segmentation mask of a 3D mesh of an object and/or otherwise perform operations described herein.

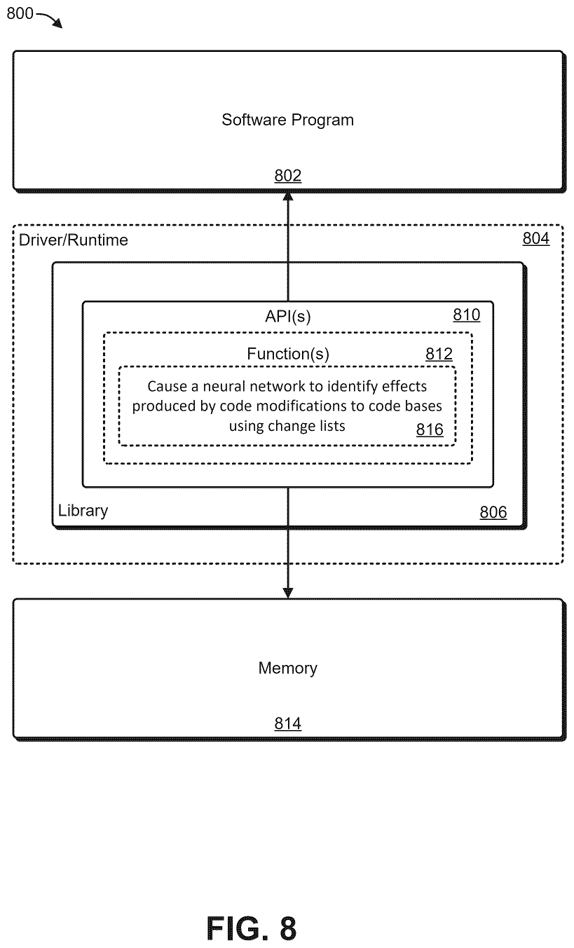

FIG. 8 is a block diagram 800 illustrating a driver and/or runtime including one or more libraries to provide one or more application programming interfaces (APIs), according to at least one embodiment. In at least one embodiment, a software program 802 is a software module. In at least one embodiment, a software program 802 includes one or more software modules. In at least one embodiment, one or more APIs 810 are sets of software instructions that, if executed, cause one or more processors to perform one or more computational operations. In at least one embodiment, one or more APIs 810 are distributed or otherwise provided as a part of one or more libraries 806, runtimes 804, drivers 804, and/or any other grouping of software and/or executable code further described herein. In at least one embodiment, one or more APIs 810 perform one or more computational operations in response to invocation by software programs 802. In at least one embodiment, a software program 802 is a collection of software code, commands, instructions, or other sequences of text to instruct a computing device to perform one or more computational operations and/or invoke one or more other sets of instructions, such as APIs 810 or API functions 812, to be executed.

In at least one embodiment, API functions 812 included but are not limited function to verify whether objects indicated in a description of an image are depicted in said image, functions to generate a textual description of visual content, functions to accept a natural language prompt to parse, edit, modify, and/or alter a description of an image, functions to identify whether objects descripted in a caption are depicted in an image sought to be described, and functions to generate an evaluation metric of a degree of similarity between an input image sought to be captioned and a generated caption. In at least one embodiment, functionality provided by one or more APIs 810 include software functions 812, such as those usable to accelerate one or more portions of software programs 802 using one or more parallel processing units (PPUs), such as graphics processing units (GPUs). In at least one embodiment, a software program is a compiler.

In at least one embodiment, APIs 810 are hardware interfaces to one or more circuits to perform one or more computational operations. In at least one embodiment, one or more software APIs 810 described herein are implemented as one or more circuits to perform one or more techniques described in conjunction with FIGS. 1-7. In at least one embodiment, one or more software programs 802 includes instructions that, if executed, cause one or more hardware devices and/or circuits to perform one or more techniques further described in conjunction with FIGS. 1-7.

In at least one embodiment, software programs 802, such as user-implemented software programs, utilize one or more application programming interfaces (APIs) 810 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 810 provide a set of callable functions 812, referred to herein as APIs, API functions, and/or functions, that individually perform one or more computing operations, such as computing operations related to parallel computing. In at least one embodiment, one or more APIs 810 provide functions 812 to adjusting a description of an image. In at least one embodiment, one or more APIs 810 provide functions 812 to cause a neural network to perform one or more operations, such as by returning a called function to a processor where said processor invokes said neural network. In at least one embodiment, one or more APIs 810 provide functions 812 to cause neural network(s) to identify effects produced by code modifications to codebases using change lists 816, automatically generate one or more test cases and/or test codes based at least in part on one or more change lists, and/or otherwise perform any of the operations described herein.

In at least one embodiment, one or more software programs 802 interact or otherwise communicate with one or more APIs 810 to perform one or more computing operations using one or more PPUs, such as GPUs. In at least one embodiment, one or more computing operations using one or more PPUs include at least one or more groups of computing operations to be accelerated by execution at least in part by said one or more PPUs. In at least one embodiment, one or more software programs 802 interact with one or more APIs 810 to facilitate parallel computing using a remote or local interface.

In at least one embodiment, an interface is software instructions that, if executed, provide access to one or more functions 812 provided by one or more APIs 810. In at least one embodiment, a software program 802 uses a local interface when a software developer compiles one or more software programs 802 in conjunction with one or more libraries 806 including or otherwise providing access to one or more APIs 810. In at least one embodiment, one or more software programs 802 are compiled statically in conjunction with pre-compiled libraries 806 or uncompiled source code including instructions to perform one or more APIs 810. In at least one embodiment, one or more software programs 802 are compiled dynamically and said one or more software programs utilize a linker to link to one or more pre-compiled libraries 806 including one or more APIs 810.

In at least one embodiment, a software program 802 uses a remote interface when a software developer executes a software program that utilizes or otherwise communicates with a library 806 including one or more APIs 810 over a network or other remote communication medium. In at least one embodiment, one or more libraries 806 including one or more APIs 810 are to be performed by a remote computing service, such as a computing resource services provider. In another embodiment, one or more libraries 806 including one or more APIs 810 are to be performed by any other computing host providing said one or more APIs 810 to one or more software programs 802.

In at least one embodiment, a processor performing or using one or more software programs 802 calls, uses, performs, or otherwise implements one or more APIs 810 to allocate and otherwise manage memory to be used by said software programs 802. In at least one embodiment, one or more software programs 802 utilize one or more APIs 810 to allocate and otherwise manage memory to be used by one or more portions of said software programs 802 to be accelerated using one or more PPUs, such as GPUs or any other accelerator or processor further described herein. Those software programs 802 request neural network(s) to identify effects produced by code modifications to codebases using change lists, automatically generate one or more test cases and/or test codes based at least in part on one or more change lists, and/or otherwise perform any of the operations described herein.

In at least one embodiment, an API 810 is an API to facilitate parallel computing. In at least one embodiment, an API 810 is any other API further described herein. In at least one embodiment, an API 810 is provided by a driver and/or runtime 804. In at least one embodiment, an API 810 is provided by a CUDA user-mode driver. In at least one embodiment, an API 810 is provided by a CUDA runtime. In at least one embodiment, a driver 804 is data values and software instructions that, if executed, perform or otherwise facilitate operation of one or more functions 812 of an API 810 during load and execution of one or more portions of a software program 802. In at least one embodiment, a runtime 804 is data values and software instructions that, if executed, perform or otherwise facilitate operation of one or more functions 812 of an API 810 during execution of a software program 802. In at least one embodiment, one or more software programs 802 utilize one or more APIs 810 implemented or otherwise provided by a driver and/or runtime 804 to perform combined arithmetic operations by said one or more software programs 802 during execution by one or more PPUs, such as GPUs.

In at least one embodiment, one or more software programs 802 utilize one or more APIs 810 provided by a driver and/or runtime 804 to perform combined arithmetic operations of one or more PPUs, such as GPUs. In at least one embodiment, one or more APIs 810 provide combined arithmetic operations through a driver and/or runtime 804, as described above. In at least one embodiment, one or more software programs 802 utilize one or more APIs 810 provided by a driver and/or runtime 804 to allocate or otherwise reserve one or more blocks of memory 814 of one or more PPUs, such as GPUs. In at least one embodiment, one or more software programs 802 utilize one or more APIs 810 provided by a driver and/or runtime 804 to allocate or otherwise reserve blocks of memory. In at least one embodiment, one or more APIs 810 are to perform combined arithmetic operations, as described below in conjunction with any FIGS. 1-7.

To improve software programs 802 usability and/or optimization of one or more portions of said software programs 802 to be accelerated by one or more PPUs, such as GPUs, in an embodiment, one or more APIs 810 provide one or more API functions 812 to perform a software correction system usable or used by one or more computing devices as described above and further described in conjunction with FIGS. 1-7. In at least one embodiment, a block diagram 800 depicts a processor, including one or more circuits to perform one or more software programs to combine two or more application programming interfaces (APIs) into a single API. In at least one embodiment, a block diagram 800 depicts a system, including one or more processors to perform one or more software programs to combine two or more application programming interfaces (APIs) into a single API.

In at least one embodiment, at least a portion of block diagram 800 is implemented using at least a portion of any system(s) depicted in and/or described with respect to FIGS. 9A-11. In at least one embodiment, block diagram 800 is performed by processor(s) 104 of FIG. 1. In at least one embodiment, at least a portion of block diagram 800 is used to implement at least a portion of any system(s) depicted in and/or described with respect to FIGS. 9A-11.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

In at least one embodiment, generative language model system 900 can be implemented to identify effects produced by code modifications to codebases using change lists, automatically generate one or more test cases and/or test codes based at least in part on one or more change lists, and/or otherwise perform any of the operations described above or elsewhere herein. One or more circuits can be configured by software to identify effects produced by code modifications to codebases using change lists, automatically generate one or more test cases and/or test codes based at least in part on one or more change lists, and/or otherwise perform any of the operations described above or elsewhere herein.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

In at least one embodiment, generative LM 930 can be implemented to identify effects produced by code modifications to codebases using change lists, automatically generate one or more test cases and/or test codes based at least in part on one or more change lists, and/or otherwise perform any of the operations described above or elsewhere herein. One or more circuits can be configured by software to identify effects produced by code modifications to codebases using change lists, automatically generate one or more test cases and/or test codes based at least in part on one or more change lists, and/or otherwise perform any of the operations described above or elsewhere herein.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

In at least one embodiment, generative LM 930 can be implemented to identify effects produced by code modifications to codebases using change lists, automatically generate one or more test cases and/or test codes based at least in part on one or more change lists, and/or otherwise perform any of the operations described above or elsewhere herein. One or more circuits can be configured by software to identify effects produced by code modifications to codebases using change lists, automatically generate one or more test cases and/or test codes based at least in part on one or more change lists, and/or otherwise perform any of the operations described above or elsewhere herein.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

In at least one embodiment, computing device(s) 1000 can be used to identify effects produced by code modifications to codebases using change lists, automatically generate one or more test cases and/or test codes based at least in part on one or more change lists, and/or otherwise perform any of the operations described above or elsewhere herein. One or more circuits can be configured by software to identify effects produced by code modifications to codebases using change lists, automatically generate one or more test cases and/or test codes based at least in part on one or more change lists, and/or otherwise perform any of the operations described above or elsewhere herein.

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In at least one embodiment, data center 1100 can be used to identify effects produced by code modifications to codebases using change lists, automatically generate one or more test cases and/or test codes based at least in part on one or more change lists, and/or otherwise perform any of the operations described above or elsewhere herein. One or more circuits can be configured by software to identify effects produced by code modifications to codebases using change lists, automatically generate one or more test cases and/or test codes based at least in part on one or more change lists, and/or otherwise perform any of the operations described above or elsewhere herein.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:
1. One or more processors comprising processing circuitry to: use one or more first neural networks to identify one or more effects to be produced by one or more code modifications to one or more codebases based, at least in part, on at least one change list identifying the one or more code modifications; and identify information to test whether the one or more codebases produce the one or more effects.
2. The one or more processors of clause 1, wherein the processing circuitry is to: identify one or more preexisting tests in a collection of preexisting tests based, at least in part, on the one or more effects; and use one or more second neural networks to generate one or more first executable tests based, at least in part, on the one or more effects and the one or more preexisting tests identified.
3. The one or more processors of clauses 1 or 2, wherein the processing circuitry is to: update the collection of preexisting tests to include the one or more first executable tests.
4. The one or more processors of any one of clauses 1-3, wherein the processing circuitry is to: validate the one or more first executable tests; and use one or more third neural networks to generate one or more second executable tests based, at least in part, on validation of the one or more first executable tests.
5. The one or more processors of any one of clauses 1-4, wherein the processing circuitry is to: generate an abstract syntax tree (AST) based, at least in part, on a sub-portion of the one or more codebases, wherein the sub-portion is based, at least in part, on the at least one change list, the information to be identified based at least in part on the AST.
6. The one or more processors of any one of clauses 1-5, wherein the one or more effects are identified based, at least in part, on one or more semantic similarities between the at least one change list and the one or more codebases.
7. The one or more processors of any one of clauses 1-6, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLMs); a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.
8. A system comprising one or more processors to: use one or more neural networks to identify one or more effects to be produced by one or more code modifications to one or more codebases based, at least in part, on at least one change list identifying the one or more code modifications; and identify information to test whether the one or more codebases produce the one or more effects.
9. The system of clause 8, wherein the one or more processors are to: identify one or more code tests in one or more databases based, at least in part, on the one or more effects; and use the one or more neural networks to generate one or more first executable tests based, at least in part, on the one or more effects and the one or more code tests identified in the one or more databases.
10. The system of clauses 8 or 9, wherein the one or more processors are to: validate the one or more first executable tests; and use the one or more neural networks to generate one or more second executable code tests based, at least in part, on validation of the one or more first executable tests.
11. The system of any one of clauses 8-10, wherein the one or more processors are to: generate an abstract syntax tree (AST) based, at least in part, on a sub-portion of the one or more codebases, wherein the sub-portion is based, at least in part, on the at least one change list.
12. The system of any one of clauses 8-11, wherein the one or more effects are identified based, at least in part, on one or more semantic similarities between the at least one change list and the one or more codebases.
13. The system of any one of clauses 8-12, the one or more processors are to: perform one or more nodes of a graph, wherein the one or more nodes represent at least one of receiving the at least one change list, identifying the one or more effects, or identifying the information to test whether the one or more codebases produce the one or more effects.
14. The system of any one of clauses 8-13, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLMs); a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.
15. A method, comprising, using one or more neural networks to identify one or more effects resulting from one or more code modifications to one or more codebases based, at least in part, on one or more identified code changes; and identifying information relevant to evaluating whether the one or more codebases exhibit the one or more effects.
16. The method of clause 15, further comprising: identifying one or more code tests based, at least in part, on the one or more effects; and using the one or more neural networks to generate one or more first executable tests based, at least in part, on the one or more effects and the one or more code tests identified.
17. The method of clauses 15 or 16, further comprising: validating the one or more first executable tests; and using the one or more neural networks to generate one or more second executable code tests based, at least in part, on validation of the one or more first executable tests.
18. The method of any one of clauses 15-17, further comprising: generating an abstract syntax tree (AST) based, at least in part, on a sub-portion of the one or more codebases, wherein the sub-portion is based, at least in part, on the one or more identified code changes; and using the AST to identify the information to test whether the one or more codebases produce the one or more effects.
19. The method of any one of clauses 15-18, wherein the one or more effects are identified based, at least in part, on one or more semantic similarities between the one or more identified changes and the one or more codebases.
20. The method of any one of clauses 15-19, wherein the method is performed by one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLMs); a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
use one or more first neural networks to identify one or more effects to be produced by one or more code modifications to one or more codebases based, at least in part, on at least one change list identifying the one or more code modifications; and
identify information to test whether the one or more codebases produce the one or more effects.

2. The one or more processors of claim 1, wherein the processing circuitry is to:
identify one or more preexisting tests in a collection of preexisting tests based, at least in part, on the one or more effects; and
use one or more second neural networks to generate one or more first executable tests based, at least in part, on the one or more effects and the one or more preexisting tests identified.

3. The one or more processors of claim 2, wherein the processing circuitry is to update the collection of preexisting tests to include the one or more first executable tests.

4. The one or more processors of claim 2, wherein the processing circuitry is to:
validate the one or more first executable tests; and
use one or more third neural networks to generate one or more second executable tests based, at least in part, on validation of the one or more first executable tests.

5. The one or more processors of claim 1, wherein the processing circuitry is to generate an abstract syntax tree (AST) based, at least in part, on a sub-portion of the one or more codebases, wherein the sub-portion is based, at least in part, on the at least one change list, the information to be identified based at least in part on the AST.

6. The one or more processors of claim 1, wherein the one or more effects are identified based, at least in part, on one or more semantic similarities between the at least one change list and the one or more codebases.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

8. A system comprising one or more processors to:
use one or more neural networks to identify one or more effects to be produced by one or more code modifications to one or more codebases based, at least in part, on at least one change list identifying the one or more code modifications; and
identify information to test whether the one or more codebases produce the one or more effects.

9. The system of claim 8, wherein the one or more processors are to:
identify one or more code tests in one or more databases based, at least in part, on the one or more effects; and
use the one or more neural networks to generate one or more first executable tests based, at least in part, on the one or more effects and the one or more code tests identified in the one or more databases.

10. The system of claim 9, wherein the one or more processors are to:
validate the one or more first executable tests; and
use the one or more neural networks to generate one or more second executable code tests based, at least in part, on validation of the one or more first executable tests.

11. The system of claim 8, wherein the one or more processors are to:
generate an abstract syntax tree (AST) based, at least in part, on a sub-portion of the one or more codebases, wherein the sub-portion is based, at least in part, on the at least one change list.

12. The system of claim 8, wherein the one or more effects are identified based, at least in part, on one or more semantic similarities between the at least one change list and the one or more codebases.

13. The system of claim 8, the one or more processors are to:
perform one or more nodes of a graph, wherein the one or more nodes represent at least one of receiving the at least one change list, identifying the one or more effects, or identifying the information to test whether the one or more codebases produce the one or more effects.

14. The system of claim 8, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A method, comprising,
using one or more neural networks to identify one or more effects resulting from one or more code modifications to one or more codebases based, at least in part, on one or more identified code changes; and
identifying information relevant to evaluating whether the one or more codebases exhibit the one or more effects.

16. The method of claim 15, further comprising:
identifying one or more code tests based, at least in part, on the one or more effects; and
using the one or more neural networks to generate one or more first executable tests based, at least in part, on the one or more effects and the one or more code tests identified.

17. The method of claim 16, further comprising:
validating the one or more first executable tests; and
using the one or more neural networks to generate one or more second executable code tests based, at least in part, on validation of the one or more first executable tests.

18. The method of claim 15, further comprising:
generating an abstract syntax tree (AST) based, at least in part, on a sub-portion of the one or more codebases, wherein the sub-portion is based, at least in part, on the one or more identified code changes; and
using the AST to identify the information to test whether the one or more codebases produce the one or more effects.

19. The method of claim 15, wherein the one or more effects are identified based, at least in part, on one or more semantic similarities between the one or more identified changes and the one or more codebases.

20. The method of claim 15, wherein the method is performed by one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
